(19) United States
(12) Patent Application Publication
(10) Pub. No.: US 2025/0366397 A1
(43) Pub. Date: Dec. 4, 2025

(54) SYSTEM AND METHOD FOR CONTROLLING THE OPERATION OF A HARVESTING IMPLEMENT OF AN AGRICULTURAL HARVESTER

(71) Applicant: RAVEN INDUSTRIES, INC., Sioux Falls, SD (US)

(72) Inventors: Jared Ernest Kocer, Sioux Falls, SD (US); Benjamin Karl Voss, Spiritwood (CA)

(21) Appl. No.: 18/731,780

(22) Filed: Jun. 3, 2024

(51) Int. Cl. A01D 69/03; A01D 45/02; A01D 57/02; A01D 61/00

(52) U.S. Cl. CPC A01D 69/03; A01D 45/023; A01D 57/025; A01D 61/002

(57) ABSTRACT

A harvesting implement for an agricultural harvester includes a frame and an auger rotatably supported on the frame. Furthermore, the harvesting implement includes a first crop feed component configured to direct a first portion of crop material from a field toward the auger and a second crop feed component spaced apart from the first crop feed component in a lateral direction that is perpendicular to a direction of travel of the harvesting implement, with the second crop feed component configured to direct a second portion of the crop material to the auger. In this respect, when the harvesting implement travels along a turn, one of the first or second crop feed components on an outside of the turn is driven at a greater rate than the other of the first or second crop feed components.

### FIELD OF THE INVENTION

The present disclosure generally relates to agricultural harvesters and, more particularly, to systems and methods for controlling the operation of a harvesting implement of an agricultural harvester.

### BACKGROUND OF THE INVENTION

An agricultural harvester is an agricultural machine used to harvest and process crops. For example, a combine harvester may be used to harvest grain crops, such as wheat, oats, rye, barley, corn, soybeans, and flax or linseed. In general, the objective is to complete several processes, which traditionally were distinct, in one pass of the machine over a particular part of the field. In this regard, most agricultural harvesters are equipped with a harvesting implement, such as a header, which cuts and collects the crop from the field and feeds it to the base harvester for further processing. The agricultural harvester also includes a crop processing system, which performs various processing operations of the harvested crop received from the harvesting implement.

During harvesting operations, the amount of crop material being cut and collected by the harvesting implement may vary across the width of the harvesting implement. In certain instances, the harvesting implement may be operating in a manner such that one or more portions of the harvesting implement are unable to ingest the crop material at the rate at which the harvesting implement is encountering such material.

Accordingly, an improved system and method for controlling the operation of a harvesting implement of an agricultural harvester would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to a harvesting implement for an agricultural harvester. The harvesting implement includes a frame and an auger rotatably supported on the frame. Furthermore, the harvesting implement includes a first crop feed component configured to direct a first portion of crop material from a field toward the auger and a second crop feed component spaced apart from the first crop feed component in a lateral direction that is perpendicular to a direction of travel of the harvesting implement, with the second crop feed component configured to direct a second portion of the crop material to the auger. In this respect, when the harvesting implement travels along a turn, one of the first or second crop feed components on an outside of the turn is driven at a greater rate than the other of the first or second crop feed components.

In another aspect, the present subject matter is directed to a system for controlling the operation of a harvesting implement of an agricultural implement. The system includes a first crop feed component configured to direct a first portion of crop material from a field toward an auger of the harvesting implement and a first actuator configured to drive the first crop feed component. Additionally, the system includes a second crop feed component spaced apart from the first crop feed component in a lateral direction that is perpendicular to a direction of travel of the harvesting implement, with the second crop feed component configured to direct a second portion of the crop material to the auger. Moreover, the system includes a second actuator configured to drive the second crop feed component. In addition, the system includes first and second sensors configured to generate data associated with the direction of travel and the ground speed of the harvesting implement and a computing system communicatively coupled to the first and second sensors. As such, the computing system is configured to determine the ground speed of the harvesting implement based on the data generated by the first and second sensors. Furthermore, the computing system is configured to determine the direction of a turn along which the harvesting implement is traveling based on the data generated by the first and second sensors. Additionally, the computing system is configured to control the operation of the first and second actuators based on the determined ground speed and the determined direction such that one of the first or second crop feed components on an outside of the turn is driven at a greater rate than the other of the first or second crop feed components.

In a further aspect, the present subject matter is directed to a method for controlling the operation of a harvesting implement of an agricultural implement. The harvesting implement, in turn, includes a first crop feed component configured to direct a first portion of crop material from a field toward an auger of the harvesting implement and a second crop feed component configured to direct a second portion of the crop material to the auger. The method includes receiving, with a computing system, first and second sensor data associated with the direction of travel and a ground speed of the harvesting implement. Moreover, the method includes determining, with the computing system, the ground speed of the harvesting implement based on the received first and second sensor data. In addition, the method includes determining, with the computing system, the direction of a turn along which the harvesting implement is traveling based on the received first and second sensor data. Furthermore, the method includes controlling, with the computing system, the operation of first and second actuators configured to respectively drive the first and second crop feed components based on the determined ground speed and the determined direction such that one of the first or second crop feed components on the outside of the turn is driven at a greater rate than the other of the first or second crop feed components.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a partial, sectional side view of one embodiment of an agricultural harvester in accordance with aspects of the present subject matter;

FIG. 2 illustrates a top view of the embodiment of the harvesting implement of the agricultural harvester shown in FIG. 1;

FIG. 3 illustrates a perspective view of another embodiment of a harvesting implement of an agricultural harvester in accordance with aspects of the present subject matter;

FIG. 4 illustrates an enlarged, partial view of a portion of the harvesting implement shown in FIG. 3;

FIG. 5 illustrates a schematic view of one embodiment of a system for controlling the operation of a harvesting implement of an agricultural implement in accordance with aspects of the present subject matter;

FIG. 6 illustrates a flow diagram providing one embodiment of control logic for controlling the operation of a harvesting implement of an agricultural implement in accordance with aspects of the present subject matter;

FIG. 7 illustrates a schematic view of a harvesting implement of an agricultural harvesting traveling along a turn in accordance with aspects of the present subject matter; and

FIG. 8 illustrates a flow diagram of one embodiment of a method for controlling the operation of a harvesting implement of an agricultural implement in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield still a further embodiment. Thus, it is intended that the present invention covers such modifications and variations as come within the scope of the appended claims and their equivalents.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to a system and a method for controlling the operation of a harvesting implement of an agricultural implement. As will be described below, the harvesting implement includes a first crop feed component configured to direct a first portion of crop material from a field toward an auger of the harvesting implement and a first actuator configured to drive the first crop feed component. Furthermore, the harvesting implement includes a second crop feed component spaced apart from the first crop feed component in a lateral direction, with the second crop feed component configured to direct a second portion of the crop material to the auger. Additionally, the harvesting implement includes a second actuator configured to drive the second crop feed component. For example, in some embodiments, the first and second crop feed components may correspond respectively to first and second portions of a reel of the harvesting implement (e.g., when the harvesting implement is a grain header). Conversely, in other embodiments, the first and second crop feed components may respectively correspond to first and second gathering chain assemblies (e.g., when the harvesting implement is a corn header).

With the disclosed system and method, the first or second crop feed component on the outside of a turn being made by the harvesting implement is driven at a greater rate than the first or second crop feed component on the inside of the turn. More specifically, a computing system is configured to receive first and second sensor data associated with the direction of travel and the ground speed of the harvesting implement. Moreover, the computing system is configured to determine the ground speed of and/or the direction and/or the magnitude of the turn along which the harvesting implement is traveling based on the received first and second sensor data. Thereafter, the computing system is configured to control the operation of the first and second actuators based on the determined ground speed, direction, and/or magnitude such that the first or second crop feed component on the outside of the turn is driven at a greater rate than the first or second crop feed component on the inside of the turn. For example, in some embodiments, the computing system may determine first and second speeds at which to respectively drive the first and second crop feed components based on the determined ground speed, direction, and/or magnitude. In such embodiments, the computing system may then control the operation of the first and second actuators such that the first and second crop feed components are respectively driven at the determined first and second speeds.

Driving the first or second crop feed component on the outside of a turn being made by the harvesting implement at a greater rate than the first or second crop feed component on the inside of the turn improves the operation of the harvesting implement and, thus, the agricultural harvester. More specifically, when the harvesting implement travels along a turn, the portion of the harvesting implement on the outside of the turn moves at a greater ground speed than the portion of the harvesting implement on the inside of the turn. In this respect, the portion of the harvesting implement on the outside of the turn generally ingests more crop material than the portion of the harvesting implement on the inside of the turn. Conventional harvesting implements may, in certain instances, be unable to accommodate the increased crop material ingestion on the outside of the turn. However, as described above, in the disclosed system and method, the crop feed component(s) on the outside of the turn are driven at a greater rate than the crop feed component(s) on the inside of the turn. This, in turn, allows the outside crop feed component(s) to ingest the increased amount of crop material without unnecessarily increasing the load on the harvester (e.g., the load on the hydraulic system). Thus, the disclosed system and method allow the harvesting implement to accommodate variations in crop material ingestion rate across the width of the implement caused by turns, while minimizing the load on and the energy consumption of the harvester.

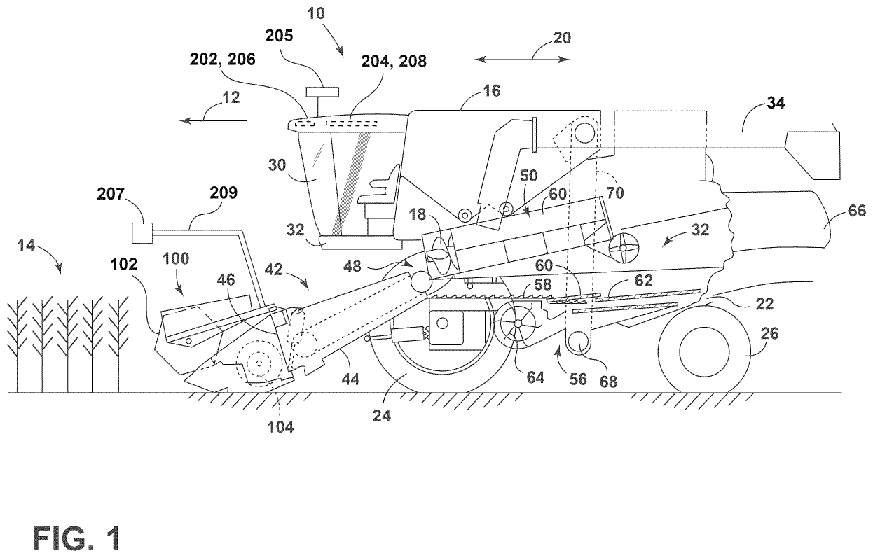

Referring now to the drawings, FIG. 1 illustrates a partial, sectional side view of an agricultural harvester 10. In general, the agricultural harvester 10 is configured to travel across a field in a forward direction of travel 12 to harvest a standing crop 14 present within the field. While traversing the field, the agricultural harvester 10 is configured to process the harvested crop material and store the grain, seed, or the like within a crop tank 16 of the harvester 10.

In the illustrated embodiment, the agricultural harvester 10 is configured as an axial-flow type combine in which the harvested crop material is threshed and separated while being advanced by and along a rotor 18 extending in an axial direction 20. However, in alternative embodiments, the agricultural harvester 10 may have any other suitable harvester configuration, such as a traverse-flow type configuration in which the rotor 18 extends in a lateral direction.

The agricultural harvester 10 includes a chassis or main frame 22 configured to support and/or couple to various components of the agricultural harvester 10. For example, in several embodiments, the agricultural harvester 10 may include a pair of driven, front wheels 24 and a pair of steerable, rear wheels 26 coupled to the frame 22. As such, the wheels 24, 26 may be configured to support the agricultural harvester 10 relative to the ground and move the agricultural harvester 10 in the forward direction of travel 12. Furthermore, the agricultural harvester 10 may include an operator's platform 28 having an operator's cab 30, a crop processing system 32, the crop tank 16, and a crop unloading tube 34 supported by the frame 22. As will be described below, the crop processing system 32 is configured to perform various processing operations on the harvested crop material as the crop processing system 32 moves the harvested crop material through the agricultural harvester 10.

Moreover, as shown in FIG. 1, the agricultural harvester 10 includes a harvesting implement 100. In general, the harvesting implement 100 is configured to cut and collect the standing crop 14 from the field for eventual delivery to the crop processing system 32. Specifically, in the illustrated embodiment, the harvesting implement 100 is configured as a grain header. In such an embodiment, the harvesting implement 100 includes a reel 102 that directs or otherwise feeds the standing crop 14 or other crop material into the harvesting implement 100. Furthermore, the harvesting implement 100 includes an auger 104 that directs the harvested crop material toward the center of the harvesting implement 100. However, as will be described below, the harvesting implement 100 may be configured in any other suitable manner, such as a corn header.

Additionally, as shown in FIG. 1, the agricultural harvester 10 includes a feeder 42 that couples to and supports the harvesting implement 100. More specifically, the feeder 42 may include a feeder housing 44 extending from a forward end 46 to an aft end 48. The forward end 46 of the feeder housing 44 may, in turn, be coupled to harvesting implement 100. Moreover, the aft end 48 of the feeder housing 44 may be pivotably coupled to the frame 22 adjacent to a threshing and separating assembly 50 of the crop processing system 32. Such a pivotable coupling may permit movement of the harvesting implement 100 relative to the field surface in the vertical direction.

As the agricultural harvester 10 is propelled in the forward direction of travel 12 over the field with the standing crop 14, crop material is severed from the stubble by a cutter bar (not shown) positioned at the front of the harvesting implement 36, The reel 102 feeds or otherwise directs the harvested crop material toward the auger 104, which, in turn, delivers the harvested crop material to the forward end 46 of the feeder housing 44. The feeder 42 then supplies the harvested crop material to the threshing and separating assembly 50. In general, the threshing and separating assembly 50 may include a cylindrical chamber 54 in which the rotor 18 is rotated to thresh and separate the harvested crop material received therein. That is, the harvested crop material is rubbed and beaten between the rotor 18 and the inner surfaces of the chamber 54 to loosen and separate the grain, seed, or the like from the straw.

The crop material separated by the threshing and separating assembly 50 may fall onto a cleaning assembly 56 of the crop processing system 32. As will be described below, the cleaning assembly 56 may include a series of oscillating components, such as one or more pans 58, pre-sieves 60, and/or sieves 62, that are configured to oscillate relative to the frame 22. As such, the separated material may be spread out via the oscillation of such components 58, 60, 62 and the grain, seeds, or the like may eventually fall through apertures defined by the sieve(s) 62. Additionally, a cleaning fan 64 may be positioned adjacent to one or more of the pre-sieve(s) 60 and the sieve(s) 62 to provide an air flow through that removes chaff and other impurities from the material present thereon. The impurities may be discharged from the agricultural harvester 10 through the outlet of a straw hood 66 positioned at the aft end of the agricultural harvester 10. The cleaned harvested crop passing through the sieve(s) 62 may then fall into a trough of an auger 68, which may transfer the harvested crop to an elevator 70 for delivery to the crop tank 16.

Furthermore, the harvester 10 may include first and second sensors 202, 204. In general, the first and second sensors 202, 204 are configured to generate data associated with the direction of travel 12 and the ground speed of the harvesting implement 100. In the embodiment shown in FIG. 1, the first sensor 202 is configured as location sensor 206 (e.g., a GNSS-based received or sensor) and the second sensor 204 is configured as a yaw sensor 208. However, as will be described below, the first and second sensors 202, 204 may be configured in any other suitable manner.

Additionally, the harvester 10 may include an imaging sensor 205. In general, the imaging sensor 205 may generate image data or image-like data indicative of the biomass (e.g., crop/plant density, thickness, yield, etc.) of a portion of the field forward of the harvesting implement 100. For example, in some embodiments, the imaging sensor 205 may include a combination of an RGB camera, a red edge camera, an IR camera, and a NIR camera. However, in alternative embodiments, the imaging sensor 205 may be configured in any other suitable manner. Moreover, in one embodiment, the imaging sensor 205 may be mounted on the top of the operator's cab 30 such that the imaging sensor 205 has a field of view directed at a portion of the field forward of the harvesting implement 100. Alternatively, the imaging sensor 205 may be mounted in any other suitable location.

Furthermore, the harvester 10 may include a transceiver-based sensor 207. In general, the transceiver-based sensor 207 may generate data indicative of the biomass (e.g., crop/plant density, thickness, yield, etc.) of a portion of the field forward of the harvesting implement 100. For example, in some embodiments, the imaging sensor 205 may be configured as a radar sensor or a ultrasonic sensor. However, in alternative embodiments, the transceiver-based sensor 207 may be configured in any other suitable manner. Moreover, in one embodiment, the transceiver-based sensor 207 may be mounted on harvesting implement 100 via an arm 209 such that the transceiver-based sensor 207 has a field of view directed at a portion of the field forward of the harvesting implement 100. Alternatively, the transceiver-based sensor 207 may be mounted in any other suitable location.

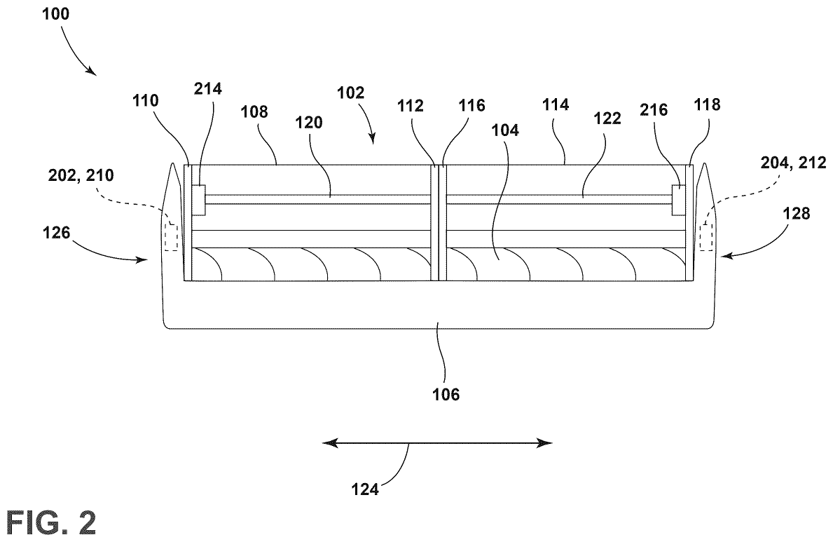

FIG. 2 illustrates a top view of the harvesting implement 100 shown in FIG. 1. More specifically, the harvesting implement 100 includes a frame 106 extending along a lateral direction 124 between a first side 126 of the harvesting implement 100 and a second side 128 of the harvesting implement 100. The lateral direction 124, in turn, extends generally perpendicular to the forward direction of travel 12. In general, the frame 106 is configured to couple to and/or support a plurality of components of the harvesting implement 100. For example, the auger 104 may be rotatably supported on the frame 106.

Moreover, the reel 102 is supported on the frame 106 of the harvesting implement 100. More specifically, in several embodiments, the reel 102 includes a first portion 108 and a second portion 114 spaced apart from the first portion 108 along the lateral direction 124. In such embodiments, the first portion 108 of the reel 102 may be supported on the frame 106 by first and second mounting arms 110, 112. Thus, the first portion 108 of the reel 102 directs a first portion of the harvested crop material toward the auger 104. Similarly, the second portion 114 of the reel 102 may be supported on the frame 106 by third and fourth mounting arms 116, 118. Thus, the second portion 114 of the reel 102 directs a second portion of the harvested crop material toward the auger 104. Furthermore, the first and second portions 108, 114 of the reel 102 are independently rotatable (e.g., can be rotated at differing speeds). However, in alternative embodiments, the reel 102 may include any other suitable number of independently rotatable portions, such as three portions, four portions, or more portions.

Additionally, as shown, the harvesting implement 100 includes first and second actuators 214, 216. In general, the first actuator 214 is configured to drive the first portion 108 of the reel 102 at a first speed (e.g., a first rotational speed). Similarly, the second actuator 216 is configured to drive the second portion 114 of the reel 102 at a second speed (e.g., a second rotational speed). As will be described below, the first and second actuators 214, 216 may be controlled such that the first or second portion 108, 114 of the reel 102 positioned on the outside of a turn being made the harvesting implement 100 is driven at a greater rate or speed than the first or second portion 108, 114 of the reel 102 positioned on the inside of the turn.

The first and second actuators 214, 216 may be configured as any suitable devices for driving the first and second portions 108, 114 of the reel 102. For example, in one embodiment, the first and second actuators 214, 216 may be respectively configured as first and second hydraulic motors. However, in alternative embodiments, the first and second actuators 214, 216 may be configured as electric motors or any other suitable devices.

As mentioned above, the first and second sensors 202, 204 are configured to generate data associated with the direction of travel 12 and the ground speed of the harvesting implement 100. As shown in FIG. 2, in some embodiments, the first and second sensors 202, 204 are configured as first and second radar sensors 210, 212. Specifically, in such embodiments, the first radar sensor 210 is positioned on the first side 126 of the harvesting implement 100 and the second radar sensor 212 is positioned on the second side 128 of the harvesting implement 100. Thus, by comparing the data generated by the first and second radar sensors 210, 212, the ground speed, direction of a turn, and the magnitude of the turn can be determined.

However, in alternative embodiments, the first and second sensors 202, 204 may be configured in any other suitable manner. For example, in one alternative embodiment, the first and second sensors 202, 204 may be configured as first and second wheels (not shown) positioned respectively on the first and second sides 126, 128 of the harvesting implement 100. Thus, by comparing the rotational speeds of the first and second wheels, the ground speed, the direction of a turn, and the magnitude of the turn can be determined.

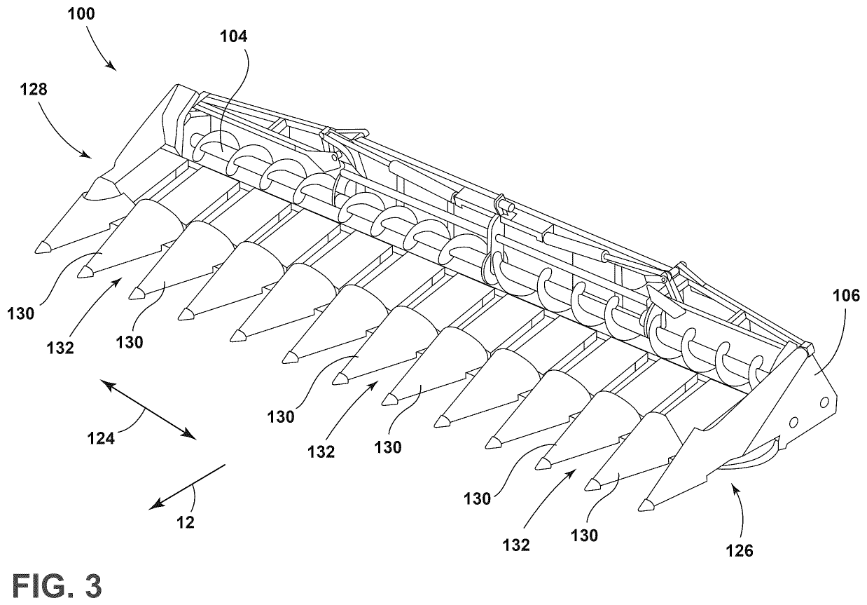

FIG. 3 illustrates a perspective view of another embodiment of the harvesting implement 100. In the embodiment illustrated in FIG. 3, the harvesting implement 100 is configured as a corn header. As such, like the embodiment of the harvesting implement 100 shown in FIG. 2, the harvesting implement 100 of FIG. 3 includes the auger 104 and the frame 106. However, unlike the embodiment of the harvesting implement 100 shown in FIG. 2, the harvesting implement 100 of FIG. 3 does not include the reel 102.

Furthermore, unlike the embodiment of the harvesting implement 100 shown in FIG. 2, the harvesting implement 100 of FIG. 3 includes a plurality of snouts 130. As shown, the snouts 130 are spaced apart in the lateral direction 124 along the forward end of the harvesting implement 100. In this respect, a stalkway 132 is defined between each adjacent pair of snouts 130. Thus, as the harvesting implement 100 travels across the field to perform a harvesting operation thereon, a row of the standing crop 14 (e.g., a row of corn plants) is fed into each stalkway 132 by the snouts 130 defining such stalkway 132.

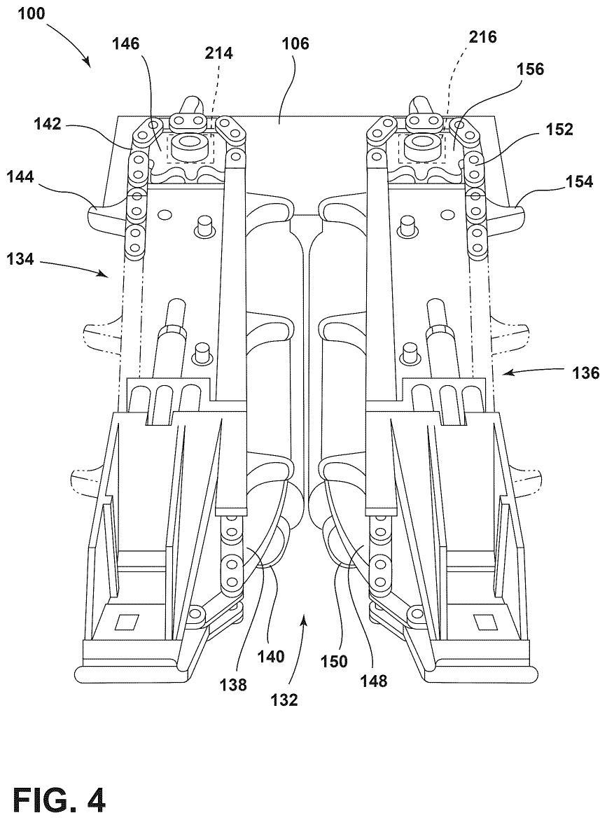

FIG. 4 illustrates an enlarged, partial view of a portion of the harvesting implement 100 shown in FIG. 3. Specifically, FIG. 4 illustrates one of the stalkways 132 with the snout 130 forming such stalkway 132 removed for clarity. In general, various components for harvesting the standing crop 14 and feeding such crop material to the auger 104 are positioned underneath each snout 130. As shown, on one side of the stalkway 132, the harvesting implement 100 includes a first gathering chain assembly 134, a first stripper or deck plate 138, and a first roller 140. Although not shown, a first crop chopper (e.g., a blade(s)) may be located underneath the first crop roller 140. The first gathering chain assembly 134 may, in turn, include a first chain 142 and a first plurality of fingers or other protuberances 144. The first chain may be rotationally driven by the first actuator 214 (e.g., a hydraulic or electric motor as described above) via a first sprocket 146. Thus, the first gathering chain assembly 134 may direct a first portion of the harvested crop material toward the auger 104. Similarly, on the other side of the stalkway 132, the harvesting implement 100 includes a second gathering chain assembly 136, a second stripper or deck plate 148, and a second roller 150. Although not shown, a second crop chopper (e.g., a blade(s)) may be located underneath the second crop roller 150. The second gathering chain assembly 136 may, in turn, include a second chain 152 and a second plurality of fingers or other protuberances 154. The second chain may be rotationally driven by the second actuator 216 (e.g., a hydraulic or electric motor as described above) via a second sprocket 156. Thus, the second gathering chain assembly 136 may direct a second portion of the harvested crop material toward the auger 104.

However, alternative embodiments, the harvesting implement 100 may be configured in any other suitable manner.

The configurations of the agricultural harvester 10 and the harvesting implement 100 described above and shown in FIGS. 1-4 are provided only to place the present subject matter in an exemplary field of use. Thus, the present subject matter may be readily adaptable to any manner of harvester configuration and/or implement configuration.

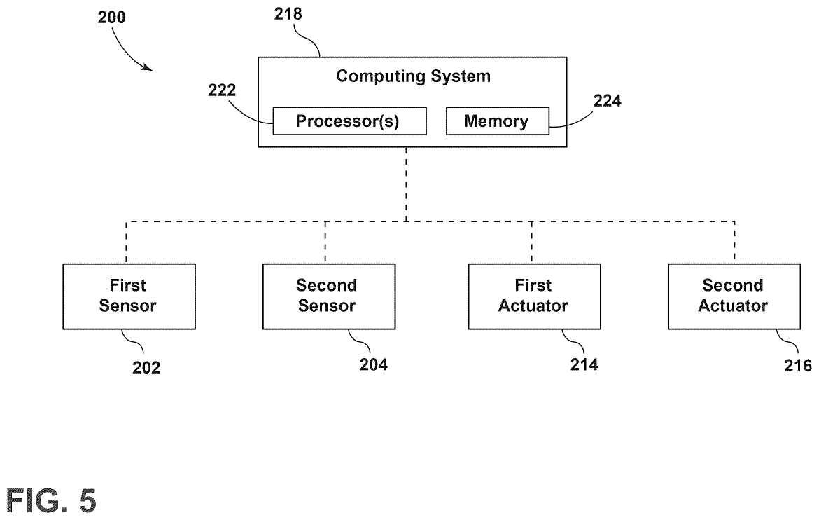

Referring now to FIG. 5, a schematic view of one embodiment of a system 200 for controlling the operation of a harvesting implement is illustrated in accordance with aspects of the present subject matter. In general, the system 200 will be described herein with reference to the agricultural harvester 10 and the harvesting implement 100 described above with reference to FIGS. 1-4. However, it should be appreciated by those of ordinary skill in the art that the disclosed system 200 may generally be utilized with agricultural harvesters having any other suitable harvester configuration and/or harvesting implements having any other suitable implement configuration.

As shown in FIG. 5, the system 200 includes one or more components of the agricultural harvester 10 and/or the harvesting implement 100. For example, in the illustrated embodiment, the system 200 includes the first sensor 202, the second sensor 204, the imaging sensor 205, the transceiver-based sensor 207, the first actuator 214, and the second actuator 216. However, in alternative embodiments, the system 200 may include any other suitable components of the agricultural harvester 10 and/or the harvesting implement 100, such as additional actuators (not shown).

Moreover, the system 200 includes a computing system 218 communicatively coupled to one or more components of the agricultural harvester 10, the harvesting implement 100, and/or the system 200 to allow the operation of such components to be electronically or automatically controlled by the computing system 218. For instance, the computing system 218 may be communicatively coupled to the first and second sensors 202, 204 via a communicative link 220. As such, the computing system 218 may be configured to receive data from the first and second sensors 202, 204 that is associated with the direction of travel and the ground speed of the harvesting implement 100. Additionally, the computing system 218 may be communicatively coupled to the imaging sensor 205 and/or the transceiver-based sensor 207 via the communicative link 220. As such, the computing system 218 may be configured to receive data from the imaging sensor 205 and/or the transceiver-based sensor 207 that is associated with the biomass of a portion of the field forward of the harvesting implement 100. Furthermore, the computing system 218 may be communicatively coupled to the first and second actuators 214, 216 via the communicative link 220. In this respect, the computing system 218 may be configured to control the operation of the first and second actuators 214, 216 to drive first and second crop feed components (e.g., the first and second portions 108, 114 of the reel 102; the first and second gathering chain assemblies 134, 136; etc.) at differing speeds. In addition, the computing system 218 may be communicatively coupled to any other suitable components of the agricultural harvester 10, the harvesting implement 100, and/or the system 200.

In general, the computing system 218 may include one or more processor-based devices, such as a given controller or computing device or any suitable combination of controllers or computing devices. Thus, in several embodiments, the computing system 218 may include one or more processor(s) 222 and associated memory device(s) 224 configured to perform a variety of computer-implemented functions. As used herein, the term “processor” refers not only to integrated circuits referred to in the art as being included in a computer, but also refers to a controller, a microcontroller, a microcomputer, a programmable logic circuit (PLC), an application specific integrated circuit, and other programmable circuits. Additionally, the memory device(s) 224 of the computing system 218 may generally comprise memory element(s) including, but not limited to, a computer readable medium (e.g., random access memory RAM)), a computer readable non-volatile medium (e.g., a flash memory), a floppy disk, a compact disk-read only memory (CD-ROM), a magneto-optical disk (MOD), a digital versatile disk (DVD) and/or other suitable memory elements. Such memory device(s) 224 may generally be configured to store suitable computer-readable instructions that, when implemented by the processor(s) 222, configure the computing system 218 to perform various computer-implemented functions, such as one or more aspects of the methods and algorithms that will be described herein. In addition, the computing system 218 may also include various other suitable components, such as a communications circuit or module, one or more input/output channels, a data/control bus and/or the like.

The various functions of the computing system 218 may be performed by a single processor-based device or may be distributed across any number of processor-based devices, in which instance such devices may be considered to form part of the computing system 218. For instance, the functions of the computing system 218 may be distributed across multiple application-specific controllers or computing devices, such as a navigation controller, an engine controller, a transmission controller, and/or the like.

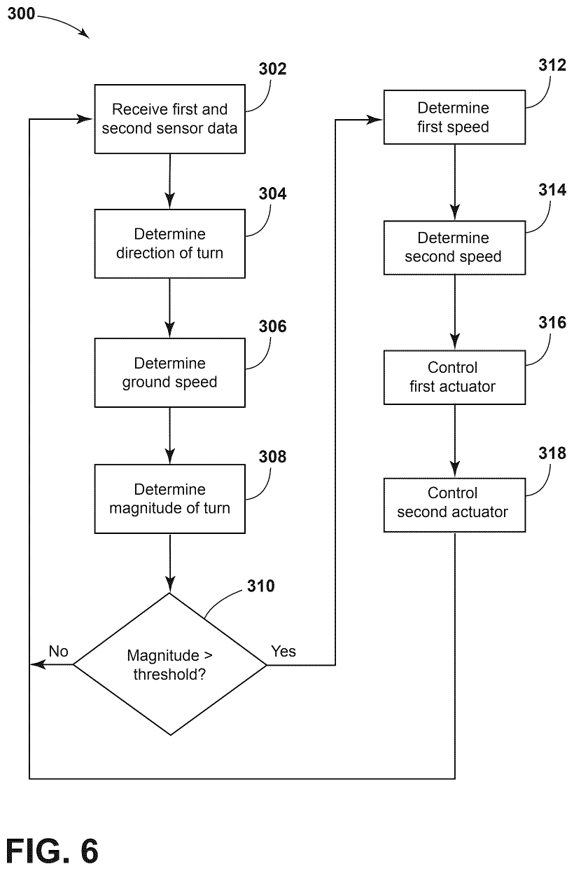

Referring now to FIG. 6, a flow diagram of one embodiment of control logic 300 that may be executed by the computing system 218 (or any other suitable computing system) for controlling an operation of a harvesting implement is illustrated in accordance with aspects of the present subject matter. Specifically, the control logic 300 shown in FIG. 6 is representative of steps of one embodiment of an algorithm that can be executed to control the operation of a harvesting implement of an agricultural harvester to allow the harvesting implement to accommodate variations in crop material ingestion rate across its width caused by turns, while minimizing the load on and the energy consumption of the harvester. However, in other embodiments, the control logic 300 may be used in association with any other suitable system, application, and/or the like for controlling the operation of a harvesting implement.

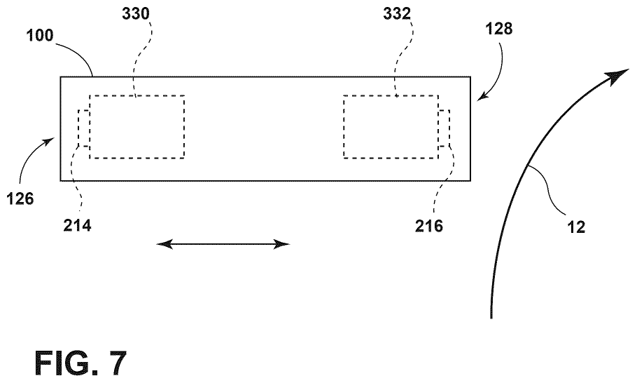

In general, the control logic 300 allows for the crop feed component(s) on the outside of a turn being made by the harvesting implement 100 to be driven at a greater rate(s) or speed(s) than the crop feed component(s) on the inside of the turn to accommodate the increased crop ingestion rate on the outside of the turn, while minimizing the load on and the energy consumption of the harvester 10. For purposes of clarity, the control logic 300 will be described below in the context of first and second crop feed components 330, 332 (FIG. 7). However, the control logic 300 may be used to control the speed at which any number of crop feed components are driven, such as three crop feed components, four crop feed components, or more crop feed components.

As used herein, a “crop feed component” is any component of a harvesting implement that conveys or transports crop material relative to the frame of the harvesting implement toward an auger of the implement. For example, in one embodiment, the crop feed components may correspond to portions of a reel of the harvesting implement (e.g., the first and second portions 108, 114 of the reel 102). In another embodiment, the crop feed components may correspond to gathering chain assemblies of the harvesting implement (e.g., the first and second gathering chain assemblies 134, 136).

For example, FIG. 7 illustrates a schematic view of the harvesting implement 100 of the agricultural harvester 10 traveling along a turn (as indicated by the curved direction of travel 12). As shown, the harvesting implement 100 includes a first crop feed component driven by the first actuator 214 and configured to direct a first portion of crop material from a field toward an auger (e.g., the auger 104) of the harvesting implement 100. Moreover, the first crop feed component 300 is positioned on the outside of the turn. For example, the first crop feed component 330 may be the first portion 108 of the reel 102 shown in FIG. 2, the first gathering chain assembly 134 shown in FIG. 4, or the like). Similarly, the harvesting implement 100 includes a second crop feed component 332 spaced apart from the first crop feed component 330 along the lateral direction 124. Furthermore, the second crop feed component 332 is driven by the actuator 216 and configured to direct a second portion of crop material from the field toward the auger. Moreover, the second crop feed component 332 is positioned on the inside of the turn. For example, the second crop feed component 332 may be the second portion 114 of the reel 102 shown in FIG. 2, the second gathering chain assembly 136 shown in FIG. 4, or the like).

As shown in FIG. 6, at (302), the control logic 300 includes receiving first and second sensor data associated with the direction of travel and the ground speed of the harvesting implement. Specifically, as mentioned above, in several embodiments, the computing system 218 may be communicatively coupled to the first and second sensors 202, 204 via the communicative link 220. In this respect, as the harvester 10 travels across the field to perform a harvesting operation thereon, the computing system 218 may receive data from the first and second sensors 202, 204. Such data may, in turn, be indicative of or otherwise associated with the direction of travel and the ground speed of the harvesting implement 100.

Furthermore, at (304), the control logic 300 includes determining the direction of a turn along which the harvesting implement is traveling based on the received first and second sensor data. Specifically, in several embodiments, computing system 218 is configured to determine the direction of the turn along which the harvesting implement 100 is traveling based on the received first and second sensor data. For example, the computing system 218 may include any suitable look-up table(s), mathematical equation(s), and/or algorithm(s) stored within its memory device(s) 224 that correlate the received first and second sensor data to the corresponding direction(s).

Additionally, at (306), the control logic 300 includes determining the ground speed of the harvesting implement based on the received first and second sensor data. Specifically, in several embodiments, computing system 218 is configured to determine the ground speed at which the harvesting implement 100 is traveling based on the received first and second sensor data. For example, the computing system 218 may include any suitable look-up table(s), mathematical equation(s), and/or algorithm(s) stored within its memory device(s) 224 that correlate the received first and second sensor data to the corresponding ground speed value(s). As will be described below, the computing system 218 is configured to control the operation of the first and second actuators 214, 216 based on the direction determined at (304) and the ground speed determined at (306) such that one of the first or second crop feed components 330, 332 on the outside of the turn is driven at a greater rate or speed than the other of the first or second crop feed components 330, 332.

Moreover, at (308), the control logic 300 includes determining the magnitude of the turn along which the harvesting implement is traveling based on the received first and second sensor data. Specifically, in several embodiments, computing system 218 is configured to determine the magnitude of the turn along which the harvesting implement 100 is traveling based on the received first and second sensor data. For example, the computing system 218 may include any suitable look-up table(s), mathematical equation(s), and/or algorithm(s) stored within its memory device(s) 224 that correlate the received first and second sensor data to the corresponding magnitude value(s). As will be described below, the computing system 218 may be configured to control the operation of the first and second actuators 214, 216 based on the direction determined at (304), the ground speed determined at (306), and the magnitude determined at (308). In addition, (304), (306), and (308) may be performed in any order.

In addition, at (310), the control logic 300 includes comparing the determined magnitude to a minimum threshold value. Specifically, in several embodiments, the computing system 218 may be configured to compare the magnitude determined (308) to a minimum threshold value. When the determined magnitude falls below the minimum threshold value, the turn being made by the harvesting implement 100 may not be sharp enough to warrant adjusting the speed at which the first and second crop feed components 330, 332 are being driven relative to each other. In such instances, the control logic 300 returns (302). Conversely, when the determined magnitude is equal to or exceeds the minimum threshold value, the turn being made by the harvesting implement 100 may be sharp enough to warrant adjusting the speed at which the first and second crop feed components 330, 332 are being driven relative to each other. In such instances, the control logic 300 proceeds to (312). That is, as will be described below, in such instances, the computing system 218 may control the operation of the first and second actuators 214, 216 such that the first or second crop feed components 330, 332 on the outside of the turn is driven at the greater rate or speed than the other of the first or second crop feed components 330, 332.

As shown in FIG. 6, at (312), the control logic 300 includes determining a first speed at which to drive the first crop feed component based on the determined ground speed, the determined direction, and/or the determined magnitude. Specifically, in several embodiments, the computing system 218 is configured to determining a first speed at which to drive the first crop feed component 330 based on the direction determined at (304), the ground speed determined at (306), and/or the magnitude determined at (308). For example, the computing system 218 may include any suitable look-up table(s), mathematical equation(s), and/or algorithm(s) stored within its memory device(s) 224 that correlates the determined ground speed, the determined direction, and/or the determined magnitude to the corresponding first speed value(s).

Furthermore, at (314), the control logic 300 includes determining a second speed at which to drive the second crop feed component based on the determined ground speed, the determined direction, and/or the determined magnitude. Specifically, in several embodiments, the computing system 218 is configured to determining a second speed at which to drive the second crop feed component 332 based on the direction determined at (304), the ground speed determined at (306), and/or the magnitude determined at (308). For example, the computing system 218 may include any suitable look-up table(s), mathematical equation(s), and/or algorithm(s) stored within its memory device(s) 224 that correlates the determined ground speed, the determined direction, and/or the determined magnitude to the corresponding second speed value(s). As will be described below, the second speed determined at (314) differs from the first speed determined at (312) when the harvesting implement 100 travels along the turn.

Additionally, at (316), the control logic 300 includes controlling the operation of a first actuator configured to drive the first crop feed component such that the first crop feed component is driven at the determined first speed. Specifically, in several embodiments, the computing system 218 is configured to control the operation of the first actuator 214 such that the first crop feed component 330 is driven at the determined first speed. For example, in some embodiments, the computing system 218 may transmit control signals to the first actuator 214 via communicative link 220. Such control signals may, in turn, instruct the first actuator 214 to operate such that the first crop feed component 330 is driven at the first speed determined at (312).

Moreover, at (318), the control logic 300 includes controlling the operation of a second actuator configured to drive the second crop feed component such that the second crop feed component is driven at the determined second speed. Specifically, in several embodiments, the computing system 218 is configured to control the operation of the second actuator 216 such that the second crop feed component 332 is driven at the determined second speed. For example, in some embodiments, the computing system 218 may transmit control signals to the second actuator 216 via communicative link 220. Such control signals may, in turn, instruct the second actuator 216 to operate such that the second crop feed component 332 is driven at the second speed determined at (342). Upon completion of (318), the control logic 300 returns to (302).

In addition, in several embodiments, the computing system 218 may be configured to control the operation of the first and second actuators 214, 216 using biomass data. More specifically, in such embodiments, as the harvester 10 travels across the field during a harvesting operation, the computing system 218 may receive one or more inputs indicative of an expected biomass parameter associated with a portion of the field forward of the harvesting implement 100. For example, in some embodiments, the computing system 218 may receive the input(s) from the imaging sensor 205 and/or the transceiver-based sensor 207 via the communicative link 220. Alternatively, in other embodiments, the computing system 218 may receive the input(s) from a remote device (not shown), such as remote server database, another agricultural machine, etc. In such embodiments, the input(s) may correspond to a variable rate file (e.g., from a sprayer that previously traveled across the field earlier in the planting season), drone imagery, satellite imagery, and/or the like. Furthermore, the computing system 218 may determine the expected biomass parameter based on the received input(s). Thereafter, the computing system 218 may control the operation of the first and second actuators 214, 216 based on the determined expected biomass parameter in addition to the direction determined at (304) and the ground speed determined at (306). For example, when determining the first and second speeds at (312) and (314), respectively, the computing system 218 may use the expected biomass parameter along with the determined direction and ground speed. By using the biomass parameter in addition to the direction and ground speed of the harvester 10, the harvesting implement 100 can better accommodate variations in crop material ingestion rate across the width of the implement 100 caused by variation in field conditions (e.g., caused by low spots in the field receiving too much water, highly alkaline soil, etc.) and by turns, while minimizing the load on and the energy consumption of the harvester.

The expected biomass parameter(s) may correspond to any suitable parameter(s) or value(s) indicative of the biomass present within the portion of the field forward of the harvesting implement 100. For example, the expected biomass parameter may correspond to the expected crop yield, the expecting crop density, the expected crop thickness, the expected total plant volume or biomass, and/or the like.

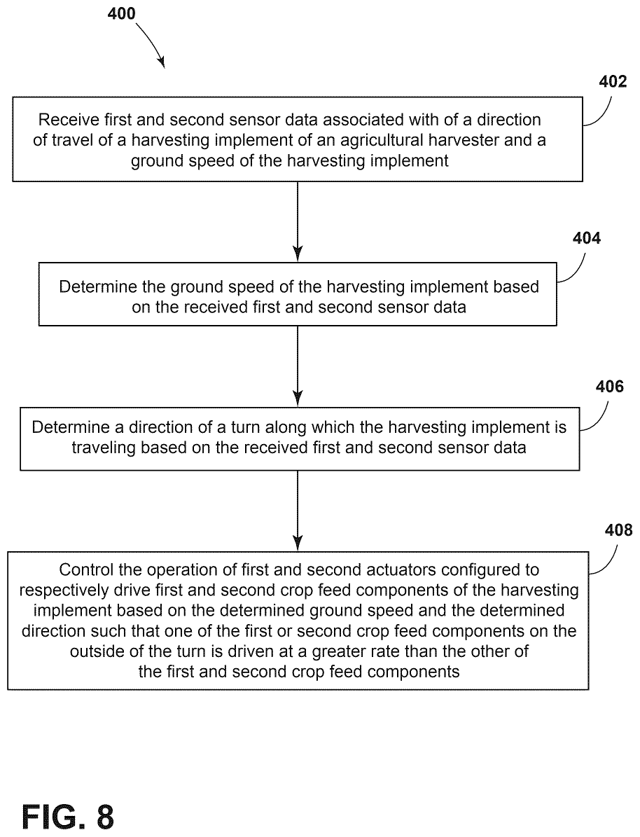

Referring now to FIG. 8, a flow diagram of one embodiment of a method 400 for controlling an operation of a harvesting implement is illustrated in accordance with aspects of the present subject matter. In general, the method 400 will be described herein with reference to the agricultural harvester 10, the harvesting implement 100, and the system 200 described above with reference to FIGS. 1-7. However, it should be appreciated by those of ordinary skill in the art that the disclosed method 400 may generally be implemented with any agricultural harvester having any suitable harvester configuration and/or any harvesting implement having any suitable implement configuration and/or within any system having any suitable system configuration. In addition, although FIG. 8 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 8, at (402), the method 400 includes receiving, with a computing system, first and second sensor data associated with the direction of travel and the ground speed of the harvesting implement. For instance, as described above, the computing system 218 may be configured to receive data from the first and second sensor 202, 204 via the communicative link 220. Such data may, in turn, be associated with the direction of travel and the ground speed of the harvesting implement 100.

Furthermore, at (404), the method 400 includes determining, with the computing system, the ground speed of the harvesting implement based on the received first and second sensor data. For instance, as described above, the computing system 218 may be configured to determine the ground speed of the harvesting implement 100 based on the received first and second sensor data.

Additionally, at (406), the method 400 includes determining, with the computing system, the direction of a turn along which the harvesting implement is traveling based on the received first and second sensor data. For instance, as described above, the computing system 218 may be configured to determine the direction of a turn along which the harvesting implement is traveling based on the received first and second sensor data.

Moreover, at (408), the method 400 includes controlling, with the computing system, the operation of first and second actuators configured to respectively drive the first and second crop feed components based on the determined ground speed and the determined direction such that one of the first or second crop feed components on the outside of the turn is driven at a greater rate than the other of the first or second crop feed components. For instance, as described above, the computing system 218 may be configured to control the operation of the first and second actuators 214, 216, which are configured to respectively drive the first and second crop feed components 330, 332 (e.g., the first and second portions 108, 114 of the reel 102; the first and second gathering chain assemblies 134, 136; etc.). Such control may be based on the determined ground speed and the determined direction such that one of the first or second crop feed components 330, 332 on the outside of the turn is driven at a greater rate or speed than the other of the first or second crop feed components 330, 332.

It is to be understood that the steps of the control logic 300 and the method 400 are performed by the computing system 218 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system 218 described herein, such as the control logic 300 and the method 400, is implemented in software code or instructions which are tangibly stored on a tangible computer readable medium. The computing system 218 loads the software code or instructions via a direct interface with the computer readable medium or via a wired and/or wireless network. Upon loading and executing such software code or instructions by the computing system 218, the computing system 218 may perform any of the functionality of the computing system 218 described herein, including any steps of the control logic 300 and the method 400 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A harvesting implement for an agricultural harvester, the harvesting implement comprising:
a frame;
an auger rotatably supported on the frame;
a first crop feed component configured to direct a first portion of crop material from a field toward the auger; and
a second crop feed component spaced apart from the first crop feed component in a lateral direction that is perpendicular to a direction of travel of the harvesting implement, the second crop feed component configured to direct a second portion of the crop material to the auger,
wherein, when the harvesting implement travels along a turn, one of the first or second crop feed components on an outside of the turn is driven at a greater rate than the other of the first or second crop feed components.

2. The harvesting implement of claim 1, further comprising:
a first actuator configured to drive the first crop feed component at a first speed; and
a second actuator configured to drive the second crop feed component and a second speed,
wherein the first and second speeds differ when the harvesting implement travels along the turn.

3. The harvesting implement of claim 2, wherein the first actuator comprises a first hydraulic motor and the second actuator comprises a second hydraulic motor.

4. The harvesting implement of claim 1, wherein the first crop feed component comprises a first portion of a reel and the second crop feed component comprises a second portion of the reel.

5. The harvesting implement of claim 1, wherein the first crop feed component comprises a first gathering chain assembly and the second crop feed component comprises a second gathering chain assembly.

6. A system for controlling an operation of a harvesting implement of an agricultural implement, the system comprising:
a first crop feed component configured to direct a first portion of crop material from a field toward an auger of the harvesting implement;
a first actuator configured to drive the first crop feed component;
a second crop feed component spaced apart from the first crop feed component in a lateral direction that is perpendicular to a direction of travel of the harvesting implement, the second crop feed component configured to direct a second portion of the crop material to the auger;
a second actuator configured to drive the second crop feed component;
first and second sensors configured to generate data associated with the direction of travel and a ground speed of the harvesting implement; and
a computing system communicatively coupled to the first and second sensors, the computing system configured to:
determine the ground speed of the harvesting implement based on the data generated by the first and second sensors;
determine a direction of a turn along which the harvesting implement is traveling based on the data generated by the first and second sensors; and
control an operation of the first and second actuators based on the determined ground speed and the determined direction such that one of the first or second crop feed components on an outside of the turn is driven at a greater rate than the other of the first or second crop feed components.

7. The system of claim 6, wherein the first crop feed component comprises a first portion of a reel and the second crop feed component comprises a second portion of the reel.

8. The system of claim 6, wherein the first crop feed component comprises a first gathering chain assembly and the second crop feed component comprises a second gathering chain assembly.

9. The system of claim 6, wherein, when controlling the operation of the first and second actuators, the computing system is configured to:
determine a first speed at which to drive the first crop feed component based on the determined ground speed and the determined direction;
determine a second speed at which to drive the second crop feed component based on the determined ground speed and the determined direction, the second speed differing from the first speed when the harvesting implement travels along the turn;
control the operation of the first actuator such that the first crop feed component is driven at the determined first speed; and
control the operation of the second actuator such that the second crop feed component is driven at the determined second speed.

10. The system of claim 6, wherein:
the computing system is further configured to determine a magnitude of a turn along which the harvesting implement is traveling based on the data generated by the first and second sensors; and
when controlling the operation of the first and second actuators, the computing system is configured to control the operation of the first and second actuators based on the determined ground speed, the determined direction, and the determined magnitude.

11. The system of claim 10, wherein, when controlling the operation of the first and second actuators, the computing system is configured to:
compare the determined magnitude to a minimum threshold value; and
when the determined magnitude exceeds the minimum threshold value, control the operation of the first and second actuators such that the one of the first or second crop feed components on the outside of the turn is driven at the greater rate than the other of the first or second crop feed components.

12. The system of claim 6, wherein the first sensor comprises a location sensor and the second sensor comprises a yaw sensor.

13. The system of claim 6, further comprising:
a harvesting implement frame extending along the lateral direction between a first side and a second side,
wherein the first sensor comprises a first radar sensor positioned on the first side and the second sensor comprises a second radar sensor positioned on the second side.

14. The system of claim 6, wherein, when controlling the operation of the first and second actuators, the computing system is configured to:
receive an input indicative of a biomass parameter of a portion of the field forward of the harvesting implement;
determine the biomass parameter based on the received input; and
control the operation of the first and second actuators based on the determined ground speed, the determined direction, and the determined biomass parameter.

15. A method for controlling an operation of a harvesting implement of an agricultural implement, the harvesting implement including a first crop feed component configured to direct a first portion of crop material from a field toward an auger of the harvesting implement and a second crop feed component configured to direct a second portion of the crop material to the auger, the method comprising:
receiving, with a computing system, first and second sensor data associated with the direction of travel and a ground speed of the harvesting implement; a
determining, with the computing system, the ground speed of the harvesting implement based on the received first and second sensor data;
determining, with the computing system, a direction of a turn along which the harvesting implement is traveling based on the received first and second sensor data; and
controlling, with the computing system, an operation of first and second actuators configured to respectively drive the first and second crop feed components based on the determined ground speed and the determined direction such that one of the first or second crop feed components on an outside of the turn is driven at a greater rate than the other of the first or second crop feed components.

16. The method of claim 15, wherein the first crop feed component comprises a first portion of a reel and the second crop feed component comprises a second portion of the reel.

17. The method of claim 15, wherein the first crop feed component comprises a first gathering chain assembly and the second crop feed component comprises a second gathering chain assembly.

18. The method of claim 15, wherein controlling the operation of the first and second actuators comprises:
determining, with the computing system, a first speed at which to drive the first crop feed component based on the determined ground speed and the determined direction;
determining, with the computing system, a second speed at which to drive the second crop feed component based on the determined ground speed and the determined direction, the second speed differing from the first speed when the harvesting implement travels along the turn;
controlling, with the computing system, the operation of the first actuator such that the first crop feed component is driven at the determined first speed; and
controlling, with the computing system, the operation of the second actuator such that the second crop feed component is driven at the determined second speed.

19. The method of claim 15, further comprising:
determining, with the computing system, a magnitude of a turn along which the harvesting implement is traveling based on the data generated by the first and second sensors,
wherein controlling the operation of the first and second actuators comprises controlling, with the computing system, the operation of the first and second actuators based on the determined ground speed, the determined direction, and the determined magnitude.

20. The method of claim 19, wherein controlling the operation of the first and second actuators comprises:
comparing, with the computing system, the determined magnitude to a minimum threshold value; and
when the determined magnitude exceeds the minimum threshold value, controlling, with the computing system, the operation of the first and second actuators such that the one of the first or second crop feed components on the outside of the turn is driven at the greater rate than the other of the first or second crop feed components.
